(19) United States
(12) Patent Application Publication
(10) Pub. No.: US 2011/0174648 A1
(43) Pub. Date: Jul. 21, 2011

(54) TOOL STORAGE UNIT

(75) Inventors: Steve HUANG, Taichung City (TW); Vincent Bove, Bethlehem, CT (US)

(73) Assignee: STANLEY BLACK & DECKER, INC., New Britain, CT (US)

(21) Appl. No.: 13/009,033

(22) Filed: Jan. 19, 2011

Related U.S. Application Data
(60) Provisional application No. 61/296,795, filed on Jan. 20, 2010.

(51) Int. Cl. B25H 3/02

(52) U.S. Cl. 206/378

(57) ABSTRACT

A tool storage unit includes a base having a cavity configured to hold a plurality of sockets. The base includes a support surface configured to support the sockets, a plurality of first protrusions extending from a first wall that partially defines the cavity. The base also includes a plurality of second protrusions extending from a second wall that partially defines the cavity. The tool storage unit also includes a groove in the base that is spaced from the cavity. The groove is configured to allow the second wall to flex when the socket is being inserted into the cavity and/or removed from the cavity.

### CROSS-REFERENCE TO RELATED APPLICATIONS

This application claims the benefit of priority from United States Provisional Patent Application No. 61/296,795, filed Jan. 20, 2010, the content of which is incorporated herein by reference in its entirety.

### FIELD

The present invention is generally related to a tool storage unit, and more specifically to a tool storage unit that is configured to securely hold sockets for a socket wrench.

### BACKGROUND

Tool storage units have many configurations and storage capabilities. Storage units designed to store sockets for socket wrenches typically have designated locations for the sockets so that the sockets may be neatly organized by size. It is desirable to be able to secure the sockets within the storage unit so that if the storage unit accidentally opens while being carried or is accidentally turned over, the sockets will not fall out of the storage unit and potentially become lost.

Although there are various known ways to secure sockets to the storage unit, it is desirable to be able to easily place and secure the socket in its stored position, as well as easily remove the socket from its stored position such that the securement feature does not hinder the speed in which a mechanic can swap out sockets during use of the socket set.

It is therefore desirable to provide a tool storage unit that provides for secured socket storage, but also provides for easier removal the sockets from the unit, as compared to known tool storage units.

### SUMMARY

It is an aspect of the invention to provide a tool storage unit that includes a base having a cavity configured to hold a plurality of sockets. The base includes a support surface configured to support the sockets, and a plurality of first protrusions extending from a first wall that partially defines the cavity. Each of the first protrusions is configured to engage a first end of one of the sockets. The base includes a plurality of second protrusions extending from a second wall that partially defines the cavity. Each of the second protrusions is configured to engage an end of the socket opposite the first end so that when the socket is inserted into the cavity and onto the support surface, the first protrusion and the second protrusion hold the socket in place. The tool storage unit also includes a groove in the base. The groove is spaced from the cavity. The groove is configured to allow the second wall to flex when the socket is being inserted into the cavity and/or removed from the cavity.

According to an aspect of the invention, there is provided a tool storage unit that includes a base having a cavity configured to hold a plurality of sockets. The base includes a support surface configured to support the sockets, and a plurality of protrusions extending from an interior wall that partially defines the cavity. Each of the protrusions is configured to engage one end of one of a respective socket when the respective socket is inserted into the cavity and onto the support surface. The tool storage unit also includes a groove in the base. The groove is spaced from the cavity and positioned substantially parallel to the interior wall. The groove is configured to allow the interior wall to flex when the socket is being inserted into the cavity and/or removed from the cavity.

Other aspects, features, and advantages of the invention will become apparent from the following detailed description, the accompanying drawings, and the appended claims.

### BRIEF DESCRIPTION OF THE DRAWINGS

Embodiments of the invention will now be described, by way of example only, with reference to the accompanying schematic drawings in which corresponding reference symbols indicate corresponding parts, in which in at least one of the drawings parts are drawn to scale with respect to each other, and in which:

FIG. 1 illustrates a perspective view of a tool storage unit according to an embodiment of the invention;

FIG. 2 illustrates a cross-sectional view of the tool storage unit taken along line II-II in FIG. 1;

FIG. 3 illustrates a cross-section view of the tool storage unit with a socket being inserted into/removed from a cavity of the tool storage unit of FIG. 2;

FIG. 4 illustrates a tool storage unit according to an embodiment of the invention;

FIG. 5 illustrates an alternative tool storage unit; and

FIG. 6 illustrates an alternative tool storage unit.

### DETAILED DESCRIPTION

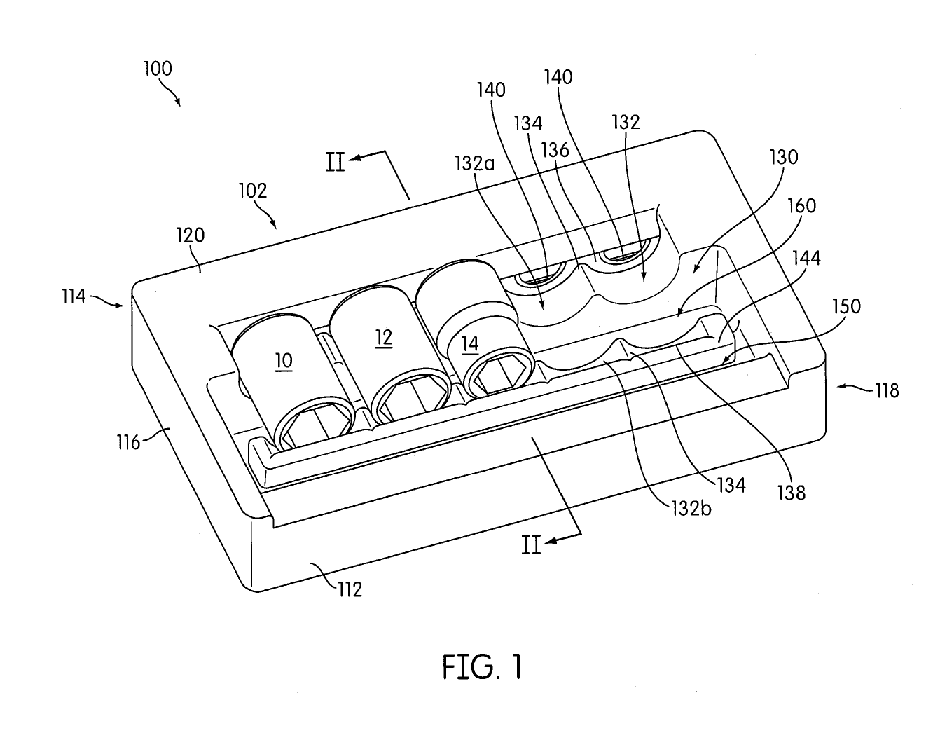

FIG. 1 illustrates a tool storage unit 100 in accordance with an embodiment of the invention. As illustrated, the tool storage unit 100 includes a base 102 having a first side wall 112, a second side wall 114 that is substantially parallel to the first side wall 112, a third side wall 116 that connects the first side wall 112 and the second side wall 114 on one end of the base 102, and a fourth side wall 118 that connects the first side wall 112 and the second side wall 114 at an opposite end of the base 102. The third side wall 116 and the fourth side wall 118 are substantially parallel to each other and substantially perpendicular to the first side wall 112 and the second side wall 114.

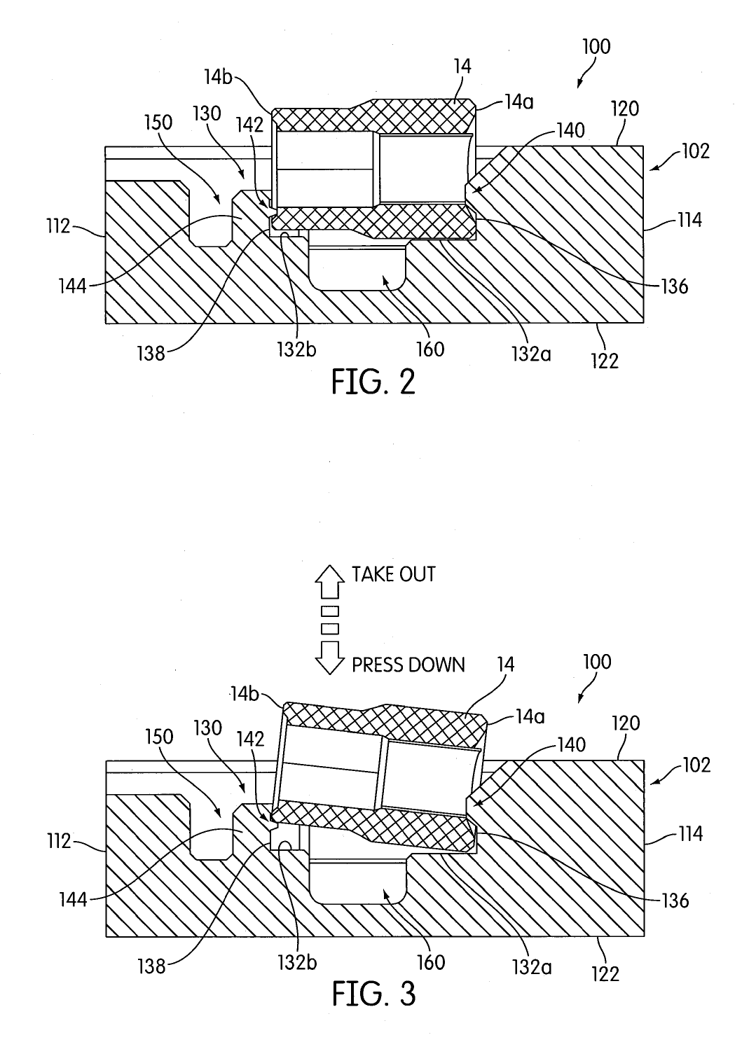

The base 102 also includes a top surface 120 and a bottom surface 122 (see FIGS. 2 and 3) that are substantially parallel to one another and substantially perpendicular to the side walls 112, 114, 116, 118. The base 102 also includes a cavity 130 that is configured to hold a plurality of sockets 10, 12, 14. The cavity 130 is open to the top surface 120 and is defined by a plurality of surfaces, as discussed in further detail below.

The base 102 includes a support surface 132 that is configured to support the sockets 10, 12, 14. As illustrated in FIG. 1, the support surface 132 may be contoured and have a plurality of concave portions 132a that substantially complement the convex shapes of the outer surfaces of the sockets 10, 12, 14. The concave portions 132a may have substantially the same size, or may have different sizes that more closely complement the size of the socket that is to be stored on that particular concave portion 132a. A ridge 134 may separate adjacent concave portions 132a, as illustrated in FIG. 1. In an embodiment (not shown), the support surface may be substantially flat and parallel to the top surface 120 and the bottom surface 122. The illustrated embodiment is not intended to be limiting in any way.

FIG. 2 illustrates a cross-section of the tool storage unit 100 taken along line II-II in FIG. 1. As illustrated, the base 102 also includes a first interior wall that provides a first socket end engaging surface 136 and a second interior wall 144 that provides a second socket end engaging surface 138 that is spaced from and substantially parallel to the first socket end engaging surface 136. The first socket end engaging surface 136 is configured to engage one end of a socket 14A, and the second socket end engaging surface 138 is configured to engage an opposite end of the socket 14B, as illustrated in FIG. 2.

A first protrusion 140 protrudes from the first socket end engaging surface 136, and a second protrusion 142 protrudes from the second socket end engaging surface 138. The first protrusion 140 is spaced from the support surface 132 so that a lower portion of the first end 14A of the socket 14 may be tucked under the first protrusion 140 in a manner that allows the first protrusion 140 to engage an inner portion of the socket 14, as illustrated in FIGS. 2 and 3.

The second protrusion 142 is also spaced from the support surface 132 so that a lower portion of the second end 14B of the socket 14 may be tucked under the second protrusion 142 in a manner that allows the second protrusion 142 to engage the inner portion of the socket 14, as illustrated in FIGS. 2 and 3. In the illustrated embodiment, the first protrusion 140 and the second protrusion 142 are of different sizes. In an embodiment, the first and second protrusions 140, 142 may be of the same size. In an embodiment, the first protrusions 140 are not provided and only the second protrusions 142 are provided so that the ends of the sockets engage the first socket engaging surface 136 when the sockets are inserted into the cavity 130. In such an embodiment, the second protrusions 142 hold the sockets in place in the cavity 130. The illustrated embodiment is not intended to be limiting in any way.

As illustrated in FIG. 1, the second interior wall 144 extends substantially parallel to the first side wall 112 and the second side wall 114 of the base 102. An elongated recess or groove 150 is spaced from the second interior wall 144 and is oriented substantially parallel to the second interior wall 144 and the second socket engaging surface 138. It has been found that the groove 150 facilitates the insertion and removal of the socket 14 into and out of the cavity 130 by allowing the interior wall 144 to flex, i.e., elastically deform, when the socket 14 is pressed down on the second protrusion 142 or pulled upward against the second protrusion 142. The groove 150 may be sized to provide the desired flexibility to the second interior wall 144.

A second elongated recess or groove 160 may be provided within the cavity 130 so as to break up the support surface 132 into two separated sections, as indicated by 132a and 132b in FIGS. 1-3. The second groove 160 may also provide flexibility to the base 102 to ensure that the socket 14 is securely held in the cavity 130 when the socket 14 is held in the position illustrated by FIG. 2. In addition, the second groove 160 may be used to reduce the amount of material in the tool storage unit 100, which reduces the overall weight of the unit and may reduce manufacturing costs.

The tool storage unit 100 is desirably formed from a durable plastic material, including but not limited to polypropylene, polyethylene, or acrylonitrile butadiene styrene (“ABS”). Any suitable plastic processing method may be used to form the tool storage unit 100, including but not limited to blow molding, injection molding, and thermoforming. By forming the tool storage unit 100 from a durable plastic material, the tool storage unit may be lightweight, yet durable in the event the unit 100 is accidentally dropped.

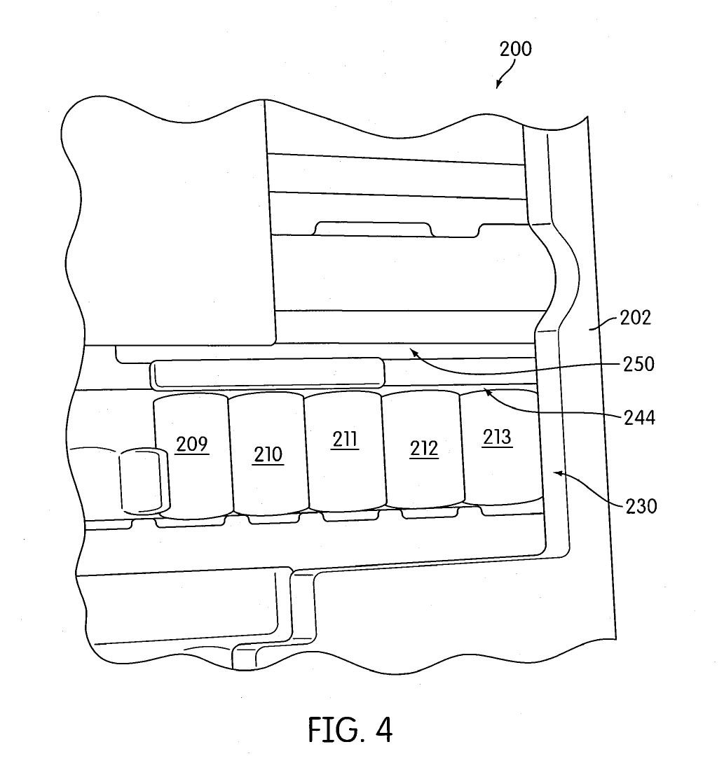

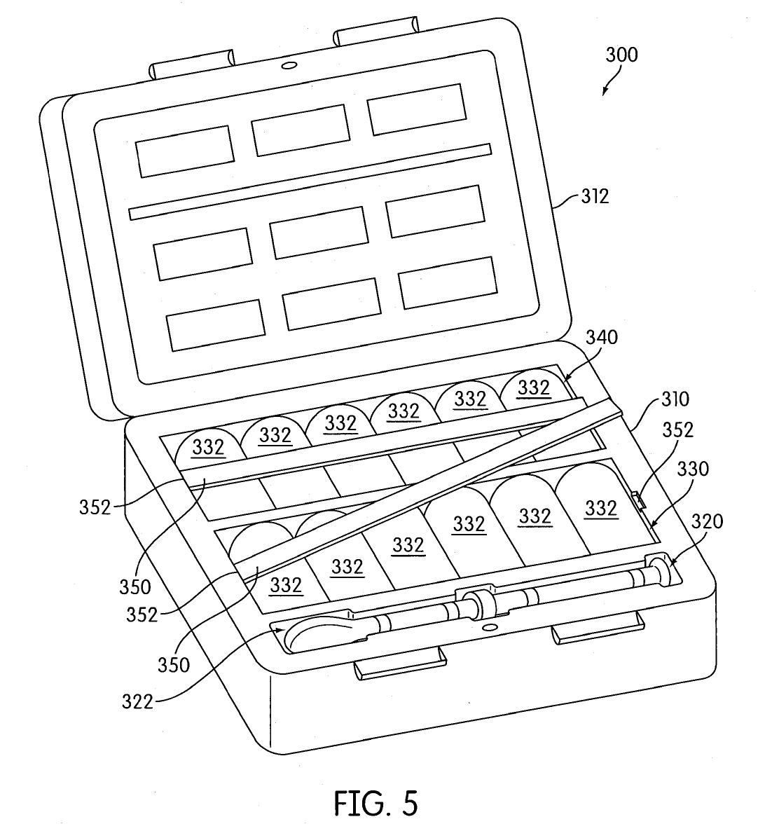

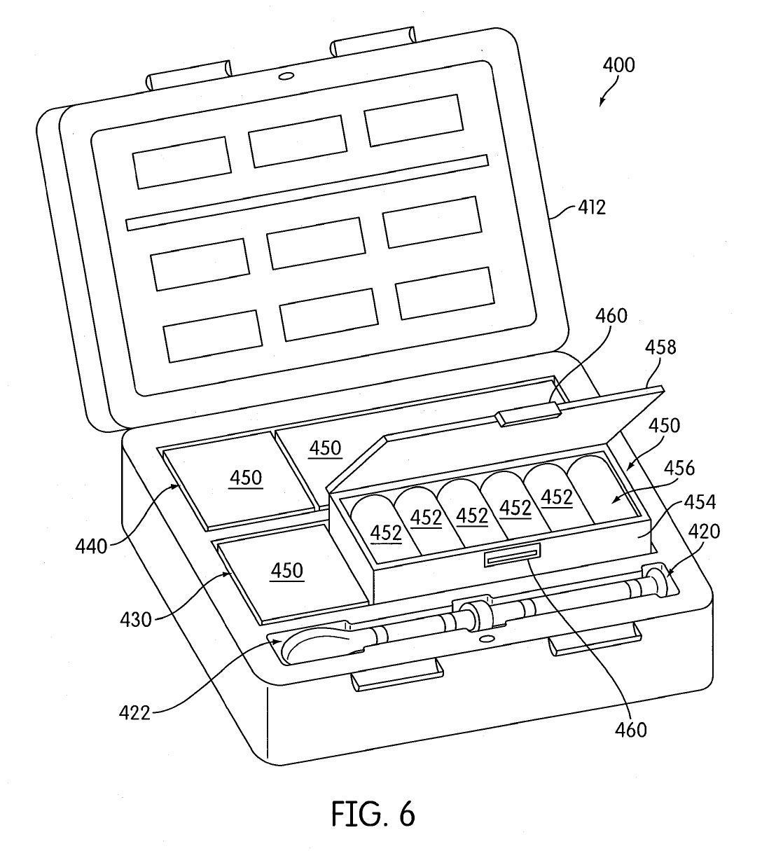

The tool storage unit 100 may be part of a larger tool storage unit, by either being placed in a suitable storage cavity in a larger tool storage unit, or may be integrated into a larger tool storage unit, such as a tool storage unit 200 that is illustrated in FIG. 4. As illustrated, the cavity 230 that holds a plurality of sockets 209, 210, 211, 212, 213 is formed in a base 202, which may also include a cover (not shown) that is hingedly connected to the base 202, in a similar manner illustrated in FIGS. 5 and 6.

Similar to the groove 150 of FIGS. 1-3, an elongated recess 250 is spaced from an substantially parallel to a wall 244 that provides a protrusion (not shown) similar to the second protrusion 142 of the base 102 of FIGS. 2 and 3. The groove 250 is configured to provide flexibility to the wall 244 so that the sockets 209, 210, 211, 212, 213 may be inserted into and removed from the cavity 230 with greater ease, as compared to a tool storage unit that does not include the groove 250.

FIG. 5 illustrates an alternative tool storage unit 300 that is configured to store a plurality of sockets, as well as a socket wrench. As illustrated, the tool storage unit 300 includes a base 310 and a cover 312 that is hingedly connected to the base 310. The base includes a first cavity 320 configured to receive a socket wrench 322, a second cavity 330 configured to receive a plurality of sockets 332, and a third cavity 340 that is also configured to receive a plurality of sockets 332. The second and third cavities 330, 340 may each include a support surface like the support surface 132 described above with respect to the tool storage unit 100 illustrated in FIGS. 1-3.

In the embodiment of the tool storage unit 300 illustrated in FIG. 5, in addition to or instead of protrusions 140, 142 being provided in the second and third cavities 330, 340 to securely hold the sockets 332 in place in the cavities 330, 340, a strap 350 is provided for each of the cavities 330, 340. As illustrated, each strap 350 is configured to be connected to the base 310 by being inserted into a slot 352 that is provided at each end of each cavity 330, 340. The straps 350 are sized so that when they are connected to the base 310, the straps 350 secure the sockets 332 to the base 310. The straps 350 may be made from a flexible, yet durable plastic. In an embodiment, each strap may be hingedly connected at one end thereof to the base 310 so that the straps cannot be separated from the base 310 and potentially misplaced.

FIG. 6 illustrates an alternative tool storage unit 400 that is configured to store a plurality of sockets and a socket wrench. The tool storage unit 400 includes a base 410 and a cover 412. The base 410 includes a first cavity 420 configured to hold a socket wrench 422, a second cavity 430, and a third cavity 440. As illustrated, the second cavity 430 and the third cavity 440 are each configured to hold a plurality of containers 450, each of which is configured to hold a plurality of sockets 452. Each container 450, which may also be considered to be a tool storage unit, includes a base 454 that defines a cavity 456 in which the sockets 452 are stored. The cavity 456 may include a support surface, similar to the support surface 132 described above with respect to the tool storage unit 100 of FIGS. 1-3. The container 450 also includes a cover 458 that is hingedly connected to the base 454. The cover 458 and the base may each include a portion of a lock 460 that are configured to interact with each other to secure the cover 458 to the base 454 when the cover 458 is in a closed position. Such locks are known in the art and are not described in further detail herein.

Different combinations of features of the embodiments of the tool storage units 100, 200, 300, 400 described herein are contemplated as being within the scope of the present invention. For example, the covers 312, 412 of the tool storage units 300, 400 of FIGS. 5 and 6 may be provide on the tool storage unit 200 of FIG. 4 or a similar cover of a different size may be hingedly connected to the base 102 of the tool storage unit 100 of FIG. 1. Similarly, in an embodiment, the base 454 of at least one of the containers 450 illustrated in FIG. 6 may include the same features of the base 102 described above with respect to FIGS. 1-3. The illustrated embodiments are not intended to be limiting in any way.

While specific embodiments of the invention have been described above, it will be appreciated that the invention may be practiced otherwise than as described. The descriptions above are intended to be illustrative, not limiting. Thus, it will be apparent to one skilled in the art that modifications may be made to the invention as described without departing from the scope of the claims set out below.

What is claimed is:

1. A tool storage unit comprising:
a base having a cavity configured to hold a plurality of sockets, the base comprising a support surface configured to support the sockets, a plurality of first protrusions extending from a first wall that partially defines the cavity, each of the first protrusions configured to engage a first end of one of the sockets, and a plurality of second protrusions extending from a second wall that partially defines the cavity, each of the second protrusions configured to engage an end of the socket opposite the first end so that when the socket is inserted into the cavity and onto the support surface, the first protrusion and the second protrusion hold the socket in place; and
a groove in the base, the groove spaced from the cavity, the groove being configured to allow the second wall to flex when the socket is being inserted into the cavity and/or removed from the cavity.

2. The tool storage unit according to claim 1, wherein the support surface is contoured to complement outer surfaces of the sockets.

3. The tool storage unit according to claim 2, wherein the contoured support surface comprises a plurality of concave portions, each concave portion being configured to engage a convex surface of one of the sockets.

4. The tool storage unit according to claim 3, wherein the concave portions have substantially the same size.

5. The tool storage unit according to claim 3, wherein the concave portions have different sizes.

6. The tool storage unit according to claim 1, wherein the base further comprises a second groove substantially parallel to the groove spaced from the cavity, the second groove being recessed from the support surface so as to split the support surface into spaced apart support surfaces.

7. The tool storage unit according to claim 1, further comprising a cover hingedly connected to the base and configured to cover the base when the cover is in a closed position.

8. The tool storage unit according to claim 7, wherein the base further comprises a second cavity configured to hold a socket wrench.

9. A tool storage unit comprising:
a base having a cavity configured to hold a plurality of sockets, the base comprising a support surface configured to support the sockets, a plurality of protrusions extending from an interior wall that partially defines the cavity, each of the protrusions configured to engage one end of one of the sockets when the respective socket is inserted into the cavity and onto the support surface; and
a groove in the base, the groove spaced from the cavity and positioned substantially parallel to the interior wall, the groove being configured to allow the interior wall to flex when the socket is being inserted into the cavity and/or removed from the cavity.

10. The tool storage unit according to claim 9, wherein the support surface is contoured to complement outer surfaces of the sockets.

11. The tool storage unit according to claim 10, wherein the contoured support surface comprises a plurality of concave portions, each concave portion being configured to engage a convex surface of one of the sockets.

12. The tool storage unit according to claim 11, wherein the concave portions have substantially the same size.

13. The tool storage unit according to claim 11, wherein the concave portions have different sizes.

14. The tool storage unit according to claim 9, wherein the base further comprises a second groove substantially parallel to the groove spaced from the cavity, the second groove being recessed from the support surface so as to split the support surface into spaced apart support surfaces.

15. The tool storage unit according to claim 9, further comprising a plurality of second protrusions extending from a second wall that partially defines the cavity, the second wall positioned substantially parallel to the first wall, each of the second protrusions configured to engage an opposite end of the socket to hold the socket in place when the socket is being supported by the support surface.
